(19) United States
(12) Patent Application Publication
(10) Pub. No.: US 2013/0278156 A1
(43) Pub. Date: Oct. 24, 2013

(54) LIGHT-EMITTING DIODE LIGHTING APPARATUS, ILLUMINATING APPARATUS AND ILLUMINATING METHOD

(71) Applicants: Yumi Hanyuda, Kanagawa-ken (JP); Koichi Honda, Kanagawa-ken (JP); Tsuyoshi Toyama, Kanagawa-ken (JP); Naoto Tokuhara, Kanagawa-ken (JP); Junya Murata, Kanagawa-ken (JP); Keitaro Takasaka, Kanagawa-ken (JP)

(72) Inventors: Yumi Hanyuda, Kanagawa-ken (JP); Koichi Honda, Kanagawa-ken (JP); Tsuyoshi Toyama, Kanagawa-ken (JP); Naoto Tokuhara, Kanagawa-ken (JP); Junya Murata, Kanagawa-ken (JP); Keitaro Takasaka, Kanagawa-ken (JP)

(73) Assignee: TOSHIBA LIGHTING & TECHNOLOGY CORPORATION, Kanagawa (JP)

(21) Appl. No.: 13/820,991

(22) PCT Filed: Sep. 22, 2011
(86) PCT No.: PCT/JP2011/071579

§ 371 Date: Jun. 10, 2013

(30) Foreign Application Priority Data
Sep. 30, 2010 (JP) 2010-222275
Aug. 12, 2011 (JP) 2011-176664

(51) Int. Cl. H05B 33/08

(52) U.S. Cl. CPC H05B 33/0839
USPC 315/186

(57) ABSTRACT

A light-emitting diode lighting apparatus includes a light source including plural grouped light-emitting diodes, plural lighting circuit parts to perform lighting control of the respective grouped light-emitting diodes of the light source individually, and a dimming control part that inputs a dimming signal from a dimming part and controls an output of each of the lighting circuit parts according to the dimming signal, and sequentially changes, when a dimming gradation is changed, outputs of the plural lighting circuit parts to new gradations in one period of the dimming signal.

### TECHNICAL FIELD

One embodiment of the present invention relates to a light-emitting diode lighting apparatus to dim and light a light-emitting diode, an illuminating apparatus and an illuminating method.

### BACKGROUND ART

An illuminating apparatus using a light-emitting diode as a light source is used as illumination for performance on a stage, studio or the like, and a PWM (Pulse Width Modulation) control is used in order to perform dimming control without changing color temperature characteristics.

However, since the dimming control using the PWM control requires control of the lighting time and extinction time of the light-emitting diode, the brightness change of the light-emitting diode becomes a discontinuous digital one, and is sometimes seen to flicker. This phenomenon appears particularly in a low gradation state in which the brightness is low. Although this phenomenon can be solved by increasing the PWM frequency, in this case, since a high-performance microcomputer (CPU) or the like is required, there is a defect that the illuminating apparatus becomes expensive.

### BRIEF DESCRIPTION OF DRAWINGS

FIG. 1 is a schematic block diagram of a light-emitting diode lighting apparatus showing a first embodiment of the invention.

FIG. 2 is a timing chart showing control of a lighting circuit at the change in dimming level showing the first embodiment of the invention.

FIG. 3 is a schematic block diagram of another light-emitting diode lighting apparatus showing the first embodiment of the invention.

FIG. 4 is a schematic block diagram of a light-emitting diode lighting apparatus showing a second embodiment of the invention,

FIG. 5 is a flowchart showing control of a lighting circuit by a dimming control part showing the second embodiment of the invention.

FIG. 6 is a flowchart showing another different control of the lighting circuit by the dimming control part showing the second embodiment of the invention.

FIG. 7 is a timing chart showing another different control of the lighting circuit at the change in dimming level showing the second embodiment of the invention.

FIG. 8 is a flowchart showing setting of delay time in the dimming control part showing the second embodiment of the invention.

FIG. 9 is a schematic block diagram of an illuminating apparatus showing a third embodiment of the invention.

FIG. 10 is a schematic front view of a light source showing the third embodiment of the invention.

FIG. 11 is a schematic front view of an LED luminaire showing the third embodiment of the invention.

FIG. 12 is a schematic side sectional view of the LED luminaire showing the third embodiment of the invention.

FIG. 13 is a schematic block diagram of another illuminating apparatus showing the third embodiment of the invention.

### DESCRIPTION OF EMBODIMENTS

According to one embodiment, a light-emitting diode lighting apparatus includes a light source including plural grouped light-emitting diodes; plural lighting circuit parts to perform lighting control of the respective grouped light-emitting diodes of the light source individually; and a dimming control part that inputs a dimming signal from a dimming part and controls an output of each of the lighting circuit parts according to the dimming signal, and sequentially changes, when a -dimming gradation is changed, outputs of the plural lighting circuit parts to new gradations in one period of the dimming signal.

The light-emitting diode lighting apparatus of the embodiment includes the light source, the lighting circuit parts and the dimming control part.

The light source includes a combination of plural groups in each of which the light-emitting diodes are grouped.

The lighting circuit parts light and control the respective grouped light-emitting diodes of the light source individually.

The dimming control part inputs the dimming signal from the dimming part for outputting the dimming signal corresponding to the dimming gradation at a specific period and controls the outputs of the respective lighting circuit parts according to the dimming signal. When the dimming gradation is changed, the control is performed so that the outputs of the plural lighting circuit parts are sequentially changed to the new gradations in the one period of the dimming signal.

Hereinafter, embodiments of the invention will be described with reference to the drawings. First, a first embodiment of the invention will be described.

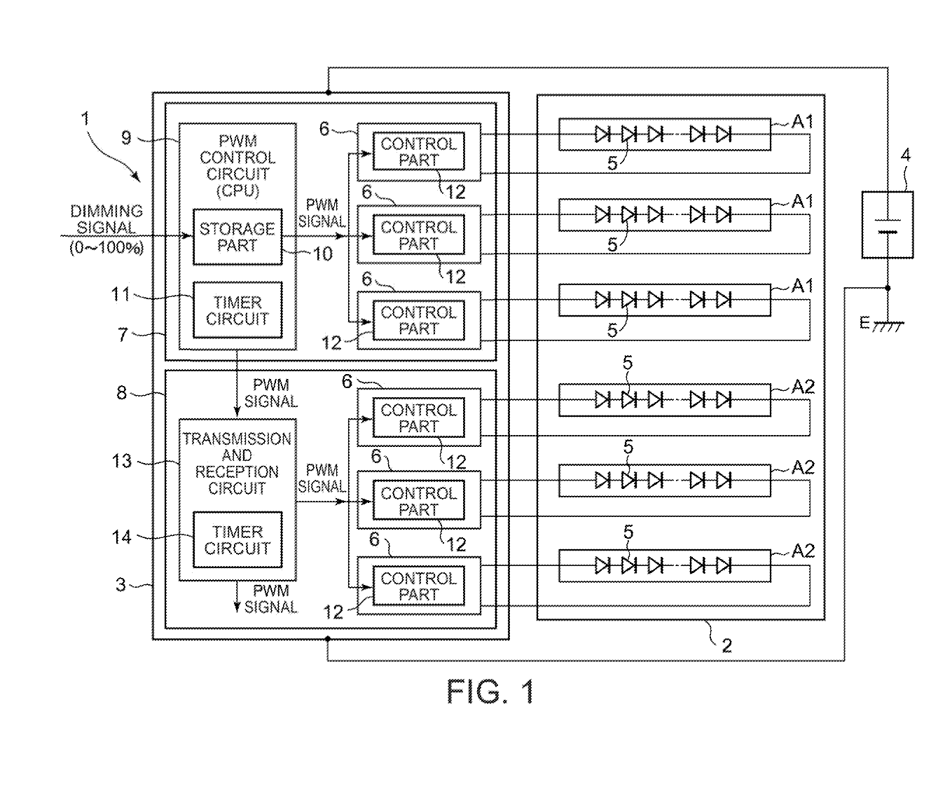

A light-emitting diode lighting apparatus (LED lighting apparatus) 1 of the first embodiment of the invention is constructed as shown in FIG. 1. The light-emitting diode lighting apparatus 1 includes a light source 2, a lighting circuit 3 as a lighting circuit part and a direct-current power supply circuit 4.

The light source 2 is constructed such that plural groups A1 and A2 of light-emitting diodes 5 are combined. Each of the groups A1 and A2 includes an LED circuit in which the plural light-emitting diodes 5 are connected in series and are mounted on a not-shown board. The plural groups A1 and the plural groups A2 are provided. Each of the groups A1 and A2 of the light-emitting diodes 5 is connected to an individual drive circuit 6. The light-emitting diode 5 is formed to emit visible light, for example, white light.

The lighting circuit 3 includes a first lighting circuit part 7 and a second lighting circuit part 8. The first and second lighting circuit parts 7 and 8 are connected to the direct-current power supply circuit 4, and operate by power supplied from the direct-current power supply circuit 4.

The first lighting circuit part 7 is made to correspond to the groups A1, and lights and controls the light-emitting diodes 5 of each of the groups A1. The second lighting circuit part 8 is made to correspond to the groups A2 as the other group, and lights and controls the light-emitting diodes 5 of each of the groups A2. Since the groups of the light-emitting diodes 5 include the two groups of the groups A1 and A2, the one second lighting circuit part 8 is provided, and is made to correspond to the one group A2. Here, if the light-emitting diodes 5 are grouped into three or more groups, the second lighting circuit parts 8 are respectively made to correspond to the groups except the one group A1 to which the first lighting circuit part 7 is made to correspond, That is, the plural second lighting circuit parts 8 are provided.

The first lighting circuit part 7 includes a PWM control circuit 9 and the drive circuits 6. The PWM control circuit 9 incorporates a storage part 10 and a timer circuit 11. Here, the PWM control circuit 9, together with a transmission and reception circuit 13 described later, constitutes a dimming control part of the embodiment,

The PWM control circuit 9 operates based on a program stored in the storage part 10. That is, the PWM control circuit 9 inputs a dimming signal outputted from a not-shown external dimming apparatus, generates a PWM signal having an on-duty (ratio of an ON period in one period, of a previously set PWM signal) corresponding to a dimming degree (0 to 100%) of the dimming signal based on a PWM generation clock, and outputs the PWM signal to the respective drive circuits 6. Here, the dimming degree (dimming gradation) of the dimming signal corresponds to the dimming level of the light source 2. The dimming signal is, for example, a DMX signal, and the PWM signals for, for example, 32 periods (one period time 0.625 ms) are outputted in one period time (for example, 20 ms) of the dimming signal.

Besides, the PWM control circuit 9 outputs the generated PWM signal to the second lighting circuit part 8 after elapse of a specific delay time. The delay time is, for example, a time obtained by dividing the one period time (for example, 20 ms) of the dimming signal by the number of groups of the light-emitting diodes 5. Here, since the groups A1 and A2 are provided and the number of groups is two, the delay time is, for example, 10 ms. The timer circuit 11 measures the delay time.

When the dimming degree of the inputted, dimming signal is changed, the PWN control circuit 9 generates a PWM signal having an on-duty corresponding to the changed dimming degree.

The drive circuit 6 is mainly formed of a control part 12, and is connected to the series connected light-emitting diodes 5. The control part 12 inputs the PWM signal outputted. from the PWM control, circuit 9, and causes the output of the drive circuit 6 to he on for the period of the on-duty of the PWM signal. By this, current supplied from the drive circuit 6 flows through the light-emitting diodes 5 of each group M for the period of the on-duty of the PWM signal, and dimming lighting is performed. As the on-duty of the signal becomes large, the period in which the current flows through the light-emitting diode 5 becomes long. Thus, the dimming level, (dimming rate) of the light-emitting diode 5 increases. That is, when the on-duty of the PWM signal is 0%, the dimming level of the light-emitting diodes 5 is 0%. When the on-duty of the PWM signal is 100%, she dimming level is 100%. Incidentally, the drive circuit 6 operates similarly also in the second lighting circuit part 8.

The second lighting circuit part 8 includes the transmission and reception circuit 13 and the drive circuits 6. The transmission and reception circuit 13 has a built-in timer circuit 14.

The transmission and reception circuit 13 inputs the PWM signal from the PWM control circuit 9 of the first lighting circuit part 7, and outputs the PWM signal to the drive circuits 6. By this, the light-emitting diodes 5 of each group A2 are dimmed and lit at the on-duty ratio (dimming level) of the PWM signal.

The timer circuit 14 measures the delay time (for example, 10 ms) from the time point when the transmission and reception circuit 13 inputs the PWM signal. The transmission and reception circuit 13 outputs the inputted PWM signal to one of other second lighting circuit parts 8 after the delay time measured by the timer circuit 14. However, here, the groups A1 and A2 are provided and the number of groups of the light-emitting diode 5 is two, and the one second lighting circuit part 8 corresponds to the group A2. Thus, another second lighting circuit part 8 to which the PWM signal is outputted is not provided. Accordingly, the timer circuit 14 may not be provided.

That is, when the number of groups of the light-emitting diodes 5 is three or more, and the plural second lighting circuit parts 8 are provided, the PWM signal is sequentially outputted to one of the other second lighting circuit parts 8 after the delay time. In this case, the first lighting circuit part 7 outputs the generated PWM signal to one of the second lighting circuit parts 8.

The direct-current power supply circuit 4 is connected to the lighting circuit 3, and supplies power to the first and second lighting circuit parts 7 and 8. The direct-current power supply circuit 4 can be made, for example, a rectifying and smoothing circuit in which a commercial alternating-current power supply is rectified and smoothed, or a direct-current power supply circuit in which a commercial alternating-current power supply is rectified or rectified and smoothed, and a rising voltage chopper circuit, a failing voltage chopper circuit or a rising-falling chopper circuit is connected thereto. Besides, the direct-current power supply circuit 4 may be a constant voltage source or a constant current source. Incidentally, the direct-current power supply circuit 4 may be provided for the first and second lighting circuit parts 7 and 8 individually.

Next, the operation of the first embodiment of the invention will be described.

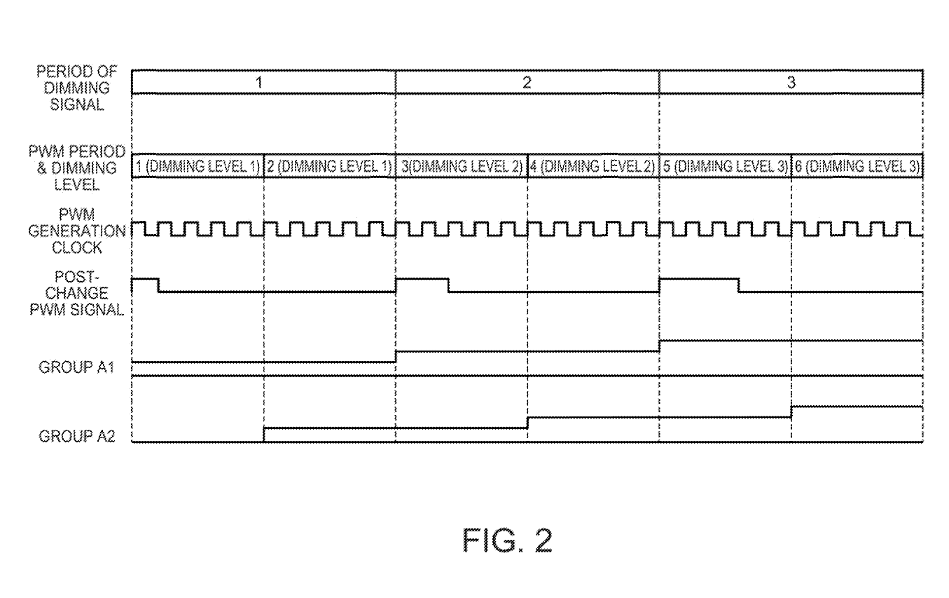

The PWM control circuit 9 of the first lighting circuit part 7 generates the PWM signal having the on-duty corresponding to the dimming level of the light-emitting diodes 5 according to the dimming signal, for example, the DMX signal out putted from the external dimming apparatus, and outputs the PWM signal to the respective drive circuits 6 of the first lighting circuit part. That is, when the dimming signal to change the dimming level of the light-emitting diodes 5 is inputted, the PWM control circuit 9 generates the post-change PWM signal, and outputs the post-change PWM signal to the respective drive circuits 6. By this, as shown in FIG. 2, the light-emitting diode 5 of the group A1 is lit at the post-change dimming level from the start of one period (for example, 20 ms) of the dimming signal. The light-emitting diode 5 of the group A1 emits visible light (white light) corresponding to the dimming level.

The PWM control circuit 9 outputs the generated PWM signal to the second lighting circuit part 8 after the delay time (for example, 10 ms) measured by the timer circuit 11. The second lighting circuit part 8 outputs the inputted PWM signal to its own drive circuits 6. By this, as shown in FIG. 2, the light-emitting diode 5 of the group A2 is lit at the post-change dimming level from the middle of one period of the dimming signal. The light-emitting diode 5 of the group A2 emits visible light (white light) corresponding to the dimming level.

In the light source 2, when the dimming level is changed, the dimming level of the light-emitting diodes 5 of the group A1 changes at the start of one period time (for example, 20 ms) of the dimming signal, and the dimming level of the light-emitting diodes 5 of the group A2 changes after the delay time obtained by dividing one period time (for example, 20 ms) of the dimming signal by 2 which is the number of groups of the light-emitting diodes 5. Thus, the dimming level changes stepwise in one period time of the dimming signal. By this, in the light source 2, the brightness change of the light-emitting diodes 5 does not become a rough digital change, but becomes a smooth digital change in total. Accordingly, there is an effect that when the dimming level of the light-emitting diodes 5 is changed, the brightness change of the light source 2 can be made difficult for a person to perceive.

The control structure is simple such that the timer circuit 11 is provided in the first lighting circuit part 7, and the PWM signal generated after the delay time is outputted when the dimming level is changed. Thus, the light-emitting diode lighting apparatus 1 can be formed at low cost.

Incidentally, in the light-emitting diode lighting apparatus 1, although the light source 2 is divided into the groups A1 and A2 of the light-emitting diodes 5, no limitation is made to this. The light-emitting diodes 5 of the light source 2 may be divided into three or more groups. In this case, the PWM control circuit 9 of the first lighting circuit part 7 outputs the generated PWM signal to the second lighting circuit part 8 after the delay time obtained by dividing one period time of the dimming signal by the number of groups of the light-emitting diodes 5. Further, the second lighting circuit part 8 may sequentially output the PWM signal from the first lighting circuit part 7 to another second lighting circuit part 8 after the delay time.

Besides, the dimming signal inputted to the PWM control circuit 9 is not limited to the DMX signal, but may be an analog signal such as a voltage value signal. In this case, one period time means a unit output time of the dimming signal.

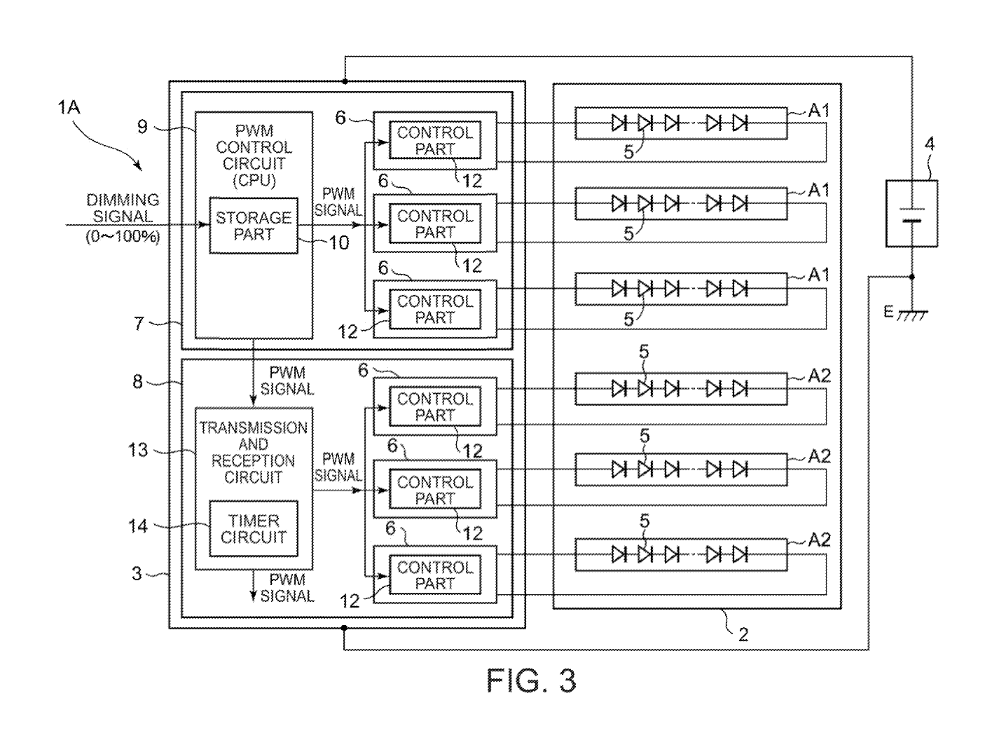

FIG. 3 is a schematic block diagram showing another light-emitting diode lighting apparatus of the first embodiment of the invention. Incidentally, the same portions as those of FIG. 1 are denoted by the same reference signs and their description is omitted.

A light-emitting diode lighting apparatus (LED lighting apparatus) 1A shown in FIG. 3 is different from the light-emitting diode lighting apparatus 1 shown in FIG. 1 in that the PWM control circuit 9 of the first lighting circuit part 7 does not include the timer circuit 11, and the transmission and reception circuit 13 of the second lighting circuit part 8 includes the timer circuit 14.

The PWM control circuit 9 outputs a generated PWM signal to drive circuits 6 of the first lighting circuit part 7, and outputs the signal to the transmission and reception circuit 13 of the second lighting circuit part 8. The timer circuit 14 of the second lighting circuit part 8 measures the time from the time point when the transmission and reception circuit 13 inputs the PWM signal. When the timer circuit 14 measures the delay time (for example, 10 ms), the transmission and reception circuit 13 outputs the inputted PWM signal to the drive circuits 6, and further outputs the signal to another second lighting circuit part 8.

Similarly to the light-emitting diode lighting apparatus 1 shown in FIG. 1, in the light-emitting diode lighting apparatus 1A of this embodiment, the brightness change of the light-emitting diodes 5 of the light source 3 does not become a rough digital change, but becomes a smooth digital change. Thus, there is an effect that when the dimming level of the light-emitting diodes 5 is changed, the brightness change of the light source 2 can be made difficult for a person to perceive.

Besides, the control structure is simple such that the first lighting circuit part 7 does not include the timer circuit 11, and instead the timer circuit 14 provided in the second lighting circuit part 8 measures the delay time, and the inputted PWM signal is outputted. Thus, there is an effect that the light-emitting diode lighting apparatus 1A can be formed at low cost.

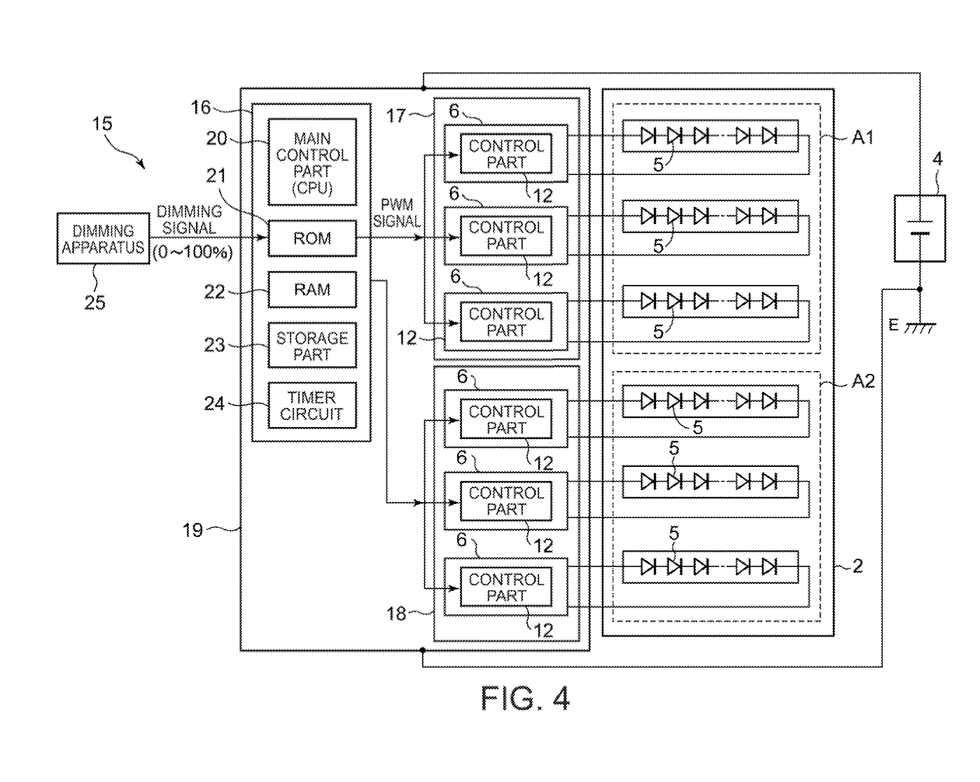

Next, a second embodiment of the invention will he described with reference to FIG. 4.

A light-emitting diode lighting apparatus (LED lighting apparatus) 15 of the second embodiment of the invention is constructed as shown in FIG. 4. In the light-emitting diode lighting apparatus 15, a portion corresponding to the PWM control circuit 9 and the transmission and reception circuit 13 of the light-emitting diode lighting apparatus 1 shown in FIG. 1 is formed as a dimming control part 16. The dimming control part 16 is connected to the drive circuits 6 including the control parts 12, and a first lighting circuit part 17 is formed. Further, other drive circuits 6 including the control parts 12 are connected to the dimming control part 16, and a second lighting circuit part 18 is formed. That is, a lighting circuit 19 includes the dimming control part 16, the first and second lighting circuit parts 17 and 18. The other structure is the same as that of the light-emitting diode lighting apparatus 1 shown in FIG. 1.

The lighting circuit 19 is connected to the direct-current power supply circuit 4, and the dimming control part 16, the first lighting circuit part 17 and the second lighting circuit 18 are respectively operated by power supplied from the direct-current power supply circuit 4.

The dimming control part 16 is formed of, for example, a microcomputer, and includes a main control part 20 provided with a CPU (Central Processing Unit), a ROM 21, a RAM 22, a storage part 23 and a timer circuit part 24. Incidentally, this structure is an example, and no limitation is made to this.

The main control part 20 performs a control operation based on a program stored in the ROM 21. That is, the main control part 20 inputs a dimming signal output ted from a dimming apparatus 25 as an external dimming part through a not-shown input part, generates a PWM signal having an on-duty corresponding to the dimming gradation (0 to 100%) of the dimming signal based on a PWM generation clock, and outputs the PWM signal to the first and second lighting circuit parts 17 and 18 individually. Here, the dimming gradation (dimming degree) of the dimming signal corresponds to the dimming level of the light source 2. The dimming signal is, for example, a DMX signal, and has gradation of 0 to 255.

The dimming apparatus 25 outputs a dimming signal (DMX signal) having dimming gradation corresponding to the dimming level (dimming rate) of the light-emitting diode 5. One period time of the dimming signal varies according to the maker, type or the like, and is 20 μs to 3 s. In this embodiment, it is assumed that the dimming apparatus 25 outputs the dimming signal with a period time of 20 ms. Accordingly, the main control part 20 of the dimming control part 16 controls so that PWM signals for, for example, 32 periods (one period time 0.625 ms) are outputted in one period time (20 ms) of the dimming signal.

When the PWM signal is generated, the main control part 20 immediately outputs the PWM signal to the first lighting circuit part 17, and outputs the PWM signal to the second lighting circuit part 18 after elapse of a previously set delay time. The delay time is, for example, a time obtained by dividing the one period time (20 ms) of the dimming signal by the number of groups of the light-emitting diodes 5. Here, since the groups A1 and A2 are provided and the number of groups is two, the delay time is, for example, 10 ms. The delay time is stored in the nonvolatile storage part 23. Besides, the delay time is measured by the timer circuit part 24.

Hereinafter, the operation of the light-emitting diode lighting apparatus 15 will be described in accordance with the control operation of the main control part 20.

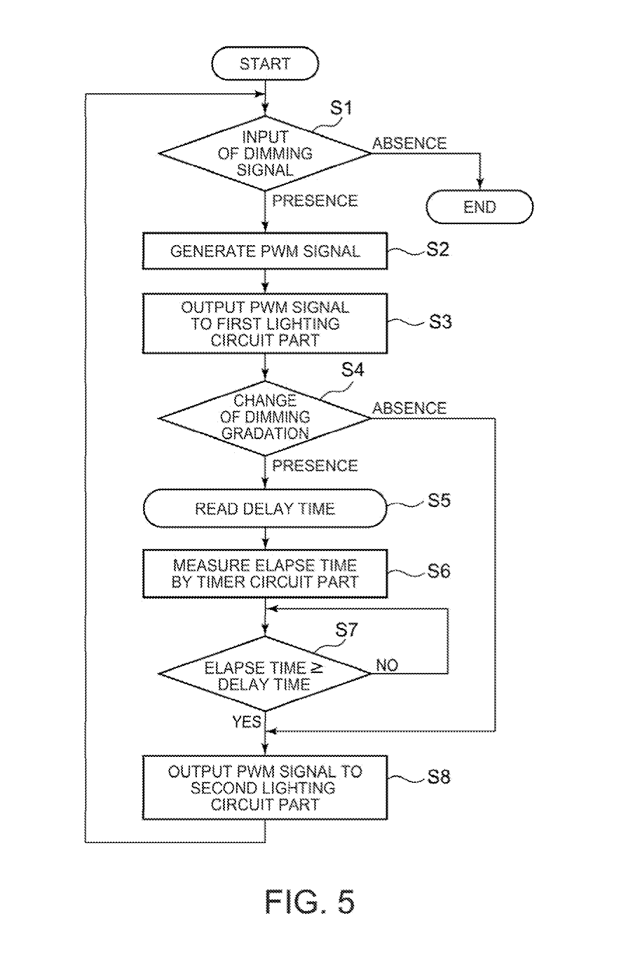

In FIG. 5, when the main control part 20 inputs the dimming signal outputted from the dimming apparatus 25 (step S1), the main control part generates the PWM signal corresponding to the dimming gradation of the dimming signal (step S2). The generated PWM signal is output ted to the first lighting circuit part 17 (step S3).

The respective drive circuits 6 of the first lighting circuit part 17 are turned on during the on-duty period of the PWM signal, and supply current to the respective LED circuits. By this, the light-emit ting diodes 5 of the group A1 are lit at a dimming level (dimming rate) corresponding to the dimming gradation (dimming degree) of the dimming signal.

The main control part 20 compares the dimming gradation of the dimming signal inputted this time and that of the dimming signal inputted just before, and determines the presence or absence of a change (step S4). Here, the dimming gradation of the dimming signal inputted just before is stored in the RAM 22. Accordingly, the dimming gradation of the dimming signal inputted this time is stored in the RAM 22. If the dimming gradation is not changed, the generated PWM signal is outputted to the second lighting circuit part 18 (step S8).

The respective drive circuits 6 of the second lighting circuit part 18 are turned on during the on-duty period of the PWM signal, and supply current to the grouped respective LED circuits. By this, the light-emitting diodes 5 of the group A2 are lit at a dimming level (dimming rate) corresponding to the dimming gradation (dimming degree) of the dimming signal.

At step S4, if the dimming gradation of the dimming signal inputted this time is changed from that of the dimming signal inputted just before, the delay time is read from, the storage part 23 (step S5), and for example, an elapsed time from the determination time point is measured by the timer circuit part 24 (step S6). Besides, when the dimming gradation of the inputted dimming signal is changed, the main control part 20 generates a PWM signal having an on-duty corresponding to the changed dimming gradation.

When the elapsed time measured by the timer circuit part 24 reaches the delay time (10 ms) read from the storage part. 23 (step S7), the main control part 20 outputs the generated PWM signal to the second lighting circuit part 18 (seep S8).

The PWM signal is inputted to one second lighting circuit part 18 after the specific delay time elapses from the time when the first lighting circuit part 17 inputs the PWM signal. By this, after the light-emitting diodes 5 of the group A1, the light-emitting diodes 5 of the group A2 are lit at the changed new dimming level (dimming rate) after the specific delay time.

Hereinafter, return is made to step S1, and the foregoing steps are repeated. As stated above, the main control part 20 (dimming control part 16) inputs the dimming signal from the dimming apparatus 25, and controls the outputs of the first and second lighting circuit parts 17 and 18 according to the dimming signal. Besides, if the dimming gradation of the inputted dimming signal is changed, the control is performed so that the outputs of the first and second lighting circuit parts 17 and 18 are sequentially changed to a new gradation in the one period time (one period 20 ms) of the dimming signal.

Next, the operation of the second embodiment of the invention will be described.

The dimming control part 16 of the lighting circuit 19 generates the PWM signal having the on-duty corresponding to the dimming level of the light-emitting diodes 5 according to the dimming signal (DMX signal) outputted from the dimming apparatus 25, and outputs the PWM signal to the respective drive circuits 6 of the first and second lighting circuit parts 17 and 18. When the dimming signal to change the dimming level of the light-emitting diodes 5 is inputted, the dimming control part 16 generates the post-change PWM signal, and outputs the post-change PWM signal to the respective drive circuits 6 of the first lighting circuit part 17. By this, as shown in FIG. 2, the light-emitting diodes 5 of the group A1 are lit at the post-change dimming level from the start of the one period time (for example, 20 ms) of the dimming signal. The light-emitting diodes 5 of the group A1 emit visible light (white light) corresponding to the dimming signal.

The dimming control part 16 outputs the generated PWM signal to the respective drive circuits 6 of the second lighting circuit part 18 after the delay time (for example, 10 ms) measured by the timer circuit part 24. By this, the light-emitting diodes 5 of the group A2 are lit at the post-change dimming level from the middle of the one period time of the dimming signal 1. The light-emitting diodes 5 of the group A2 emit visible light (white light) corresponding to the dimming level.

According to this embodiment, in the light source 2, when the dimming level is changed, the dimming level of the light-emitting diodes 5 of the group A1 changes from the start of the one period time (for example, 20 ms) of the dimming signal. Further, the dimming level of the light-emitting diodes 5 of the group A2 changes after the delay time (for example, 10 ms) obtained by dividing the one period time (for example, 20 ms) of the dimming signal by 2 which is the number of groups of the light-emitting diodes 5. Thus, the dimming level changes stepwise in the one period of the dimming signal. By this, in the light source 2, the brightness change of the light-emitting diodes 5 does not become a rough digital change, but becomes a smooth digital change in total. Accordingly, there is an effect that when the dimming level of the light-emitting diodes 5 is changed, the brightness change of the light source 2 can be made difficult for a person to perceive.

Another control (second control) of the second embodiment of the invention will be described below. In the light-emitting diode lighting apparatus 15 shown in FIG. 4, the second control further has a function of capable of setting a time in which the main control part 20 of the dimming control part 16 changes the dimming level stepwise. Here, it is assumed that one period time of the dimming signal outputted from the dimming apparatus 25 is 1.2 s (or 0.6 s), and the storage part 23 of the dimming control part 16 stores a delay time of 600 ms for 300 ms) obtained by dividing the one period time (1.2 s) (or 0.6 s) of the dimming signal by 2 which is the number of groups.

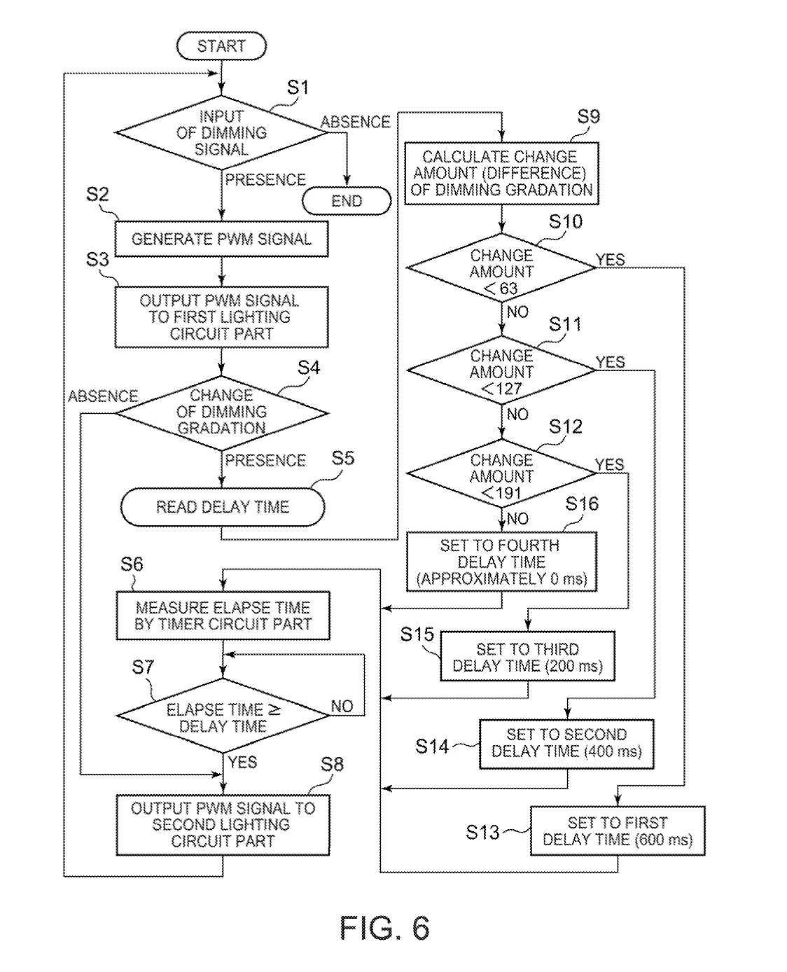

In FIG. 6, if the dimming gradation of the dimming signal inputted this time changes from the dimming gradation of the dimming signal inputted just before (step S4), the main control part 20 calculates the change amount (difference) of the dimming gradation (step S9). In addition to the delay time (600 ms) (or 300 ms) read from the storage part 23, a first delay time to a fourth delay time corresponding to the change amount of the dimming gradation are set (step S10 to step S16). That is, if the change amount of the dimming gradation is less than a first set value, for example, 63 (0 to 62) (step S10), the first delay time to be set is made the delay time (600 ms) (or 300 ms) read from the storage part 23 (step S13). Here, 63 of the set value indicates the ratio to 256 stages of 256 gradations of the DMX signal, and means that as the set value becomes large, the change of the dimming level becomes large. The same applies to following set values.

If the change amount of the dimming gradation is less than a second set value, for example, 127 (63 to 126) (step S11), the second delay time is set to, for example, 400 ms (or 200 ms). If the change amount of the dimming gradation is less than a third set value, for example, 191 (127 to 190) (step S12), the third delay time is set to, for example, 200 ms (or 100 ms) (step 315). Besides, if the change amount of the dimming gradation is not less than a fourth set value, for example, 191 (191 to 255) (step 312), the fourth delay time is set to 0 ms or a value (approximately 0 ms) possibly close to 0 ms. As stated above, as the change amount of the dimming gradation becomes large, the first to fourth delay times are made small stepwise from the delay time (600 ms) (or 300 ms) stored in the storage part 23.

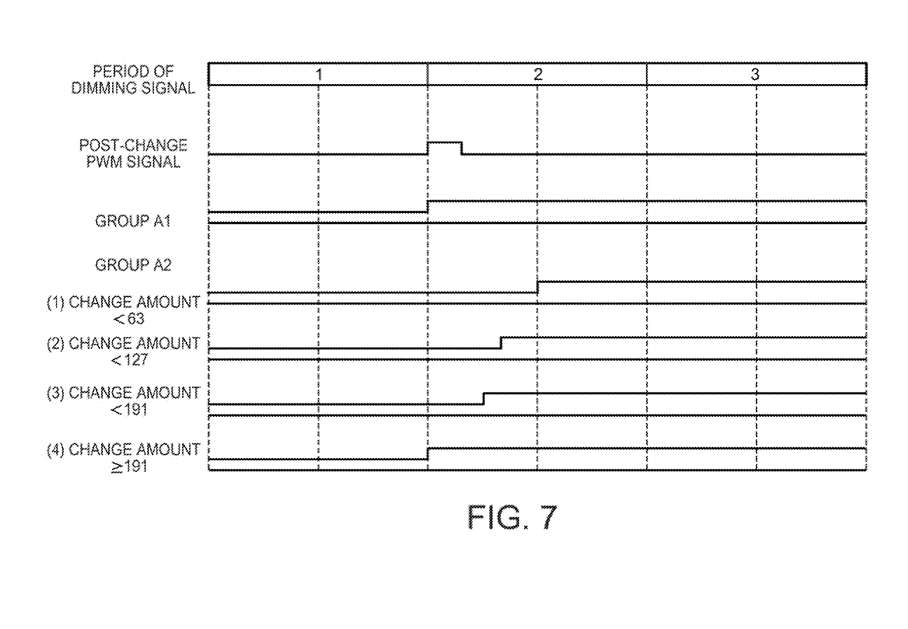

The delay time which is set correspondingly to the change amount of the dimming gradation is measured by the timer circuit part 24 (step S6), and the main control part 20 outputs the PWM signal generated after the delay time to the second lighting circuit part 18. By this, as shown in FIG. 7, the light-emitting diodes 5 of the group A2 are lit at the dimming level (dimming rate) corresponding to the dimming gradation after the delay time corresponding to the change amount of the dimming gradation relative to the light-emitting diodes 5 of the group A1. That is, the light-emitting diodes 5 of the group A1 are dimmed and lit almost simultaneously with the generation of the PWM signal. The light-emitting diodes 5 of the group A2 are dimmed and lit after almost the delay time (600 ms) (or 300 ms) after the generation of the PWM signal if the change amount of the dimming gradation is less than the first set value 63.

Similarly, if the change amount of the dimming gradation is not less than the first set value 63 and less than the second set value 127, dimming lighting is performed after the second, delay time (400 ms) (or 200 ms). If the change amount of the dimming gradation is not less than the second set value 127 and less than the third set value 191, dimming lighting is performed after the third delay time (200 ms) (or 100 ms). If the change amount of the dimming gradation is not less than the fourth set value 191, dimming lighting is performed after the fourth delay time (approximately 0 ms).

As stated above, the light-emitting diodes 5 of the groups A1 and A2 are lit stepwise at the dimming level (dimming rate) corresponding to the dimming gradation of the dimming signal. Further, as the change amount of the dimming level becomes large, the delay time after which the light-emitting diodes 5 of the group A2 are changed to the specific dimming level becomes short. When the change amount of the dimming level is large, even if the brightness change of the light-emit ting diodes 5 at the time of change of the dimming level becomes a rough digital change, the flicker is not annoying,

According to this embodiment, the dimming control part 16 is constructed so that the time (delay time) for sequentially changing the outputs of the first and second lighting circuit parts 17 and 18 can be changed according to the change amount of the dimming gradation of the dimming signal inputted from the dimming apparatus 25. Thus, there is an effect that when the dimming level of the light-emitting diodes 5 is changed, the brightness change of the light source 2 can be made difficult for a person to perceive, and further, as the change amount of the dimming level becomes large, the lighting can be performed quickly at the dimming level corresponding to the dimming gradation of the dimming signal.

This is effective when the change of illumination is desired to be perceived clearly, such as in, for example, an illumination scene of abruptly brightening or darkening.

Incidentally, in this embodiment, the light-emitting diodes 5 are divided into two groups, and the delay time stored in the storage part 23 and the first delay time are made the time value (600 ms) (or 300 ms) obtained by dividing the one period time (1.2 s) (or 0.6 s) of tire dimming signal by 2 which is the number of groups. However, when the number of groups of the light-emitting diodes 5 is 3 or more, the delay time is preferably made, for example, smaller than 600 ms (or 300 ms), and more preferably, the total delay time after the second lighting circuit part 18 is 600 ms (or 300 ms).

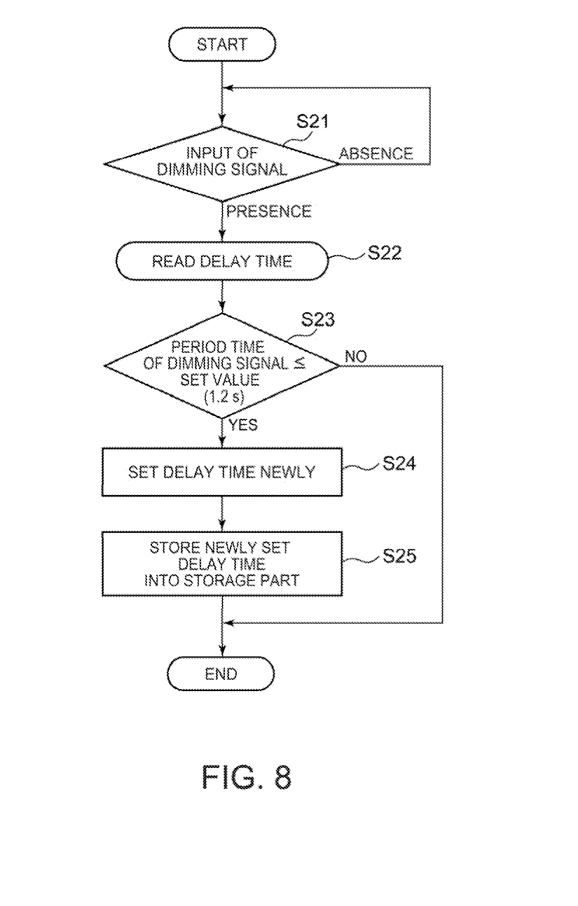

FIG. 8 shows another control (third control) in the second embodiment. That is, the main control part 20 of the dimming control part 16 is made to have a function of setting a delay time according to a period of a dimming signal outputted from the dimming apparatus 25. As stated above, in the dimming apparatus 25, one period time of the dimming signal varies according to the maker, type or the like, and is 20 μs to 3 s.

In FIG. 8, when the dimming signal is inputted (step S21), the main control part 20 reads the delay time stored in the storage part 23 (step S22), and compares the one period time of the dimming signal with the reference set value of one period time, for example, 1.2 s (step S23). If the one period time of the dimming signal is not less than the set value (1.2 s), the delay time (for example, 600 ms) stored in the storage part 23 is not changed. By this, when the dimming apparatus 25 to output the dimming signal with a period time of 1.2 s to 3 s is connected to the light-emitting diode lighting apparatus 15, and when the dimming gradation of the dimming signal is changed, the dimming control part 16 delays the timing when the generated PWM signal is outputted to the second lighting circuit part 18 by the delay time (600 ms) stored with respect to the first lighting circuit part 17.

If the one period time of the dimming signal is less than the set value (1.2 s), the main control part 20 sets the delay time (for example, 600 ms) to a new delay time (step S24). The new delay time can be made, for example, a time obtained by dividing the one period time of the dimming signal by the number of groups of the light-emitting diodes 5. The newly set delay time is stored, in the storage part 23. By this, afterwards, when the dimming gradation of the dimming signal is changed, the dimming control part 16 outputs the generated PWM signal to the second lighting circuit part 4 after elapse of the newly set delay time from the time point of output to the first lighting circuit part 3.

As stated above, the dimming control part 16 variably controls the time (delay time) for sequentially changing the outputs of the first and second lighting circuit parts 17 and 18 according to the period of the dimming signal inputted from the dimming apparatus 25.

According to this embodiment, when the dimming apparatus 25 different in maker or type is connected to the light-emitting diode lighting apparatus 15, and when the dimming level of the light-emitting diode 5 is changed, the brightness change of the light source 2 can be made difficult for a person to perceive. Further, when the change amount of the dimming level is large, the lighting can be performed quickly at the dimming level corresponding to the dimming gradation of the dimming signal. Moreover, the time (delay time) for sequentially changing the output of the second lighting circuit part 18 from the output time point of the first lighting circuit part 17 can be automatically set. Thus, there is an effect that labor saving can be achieved by this.

Next, a third embodiment of the invention will be described.

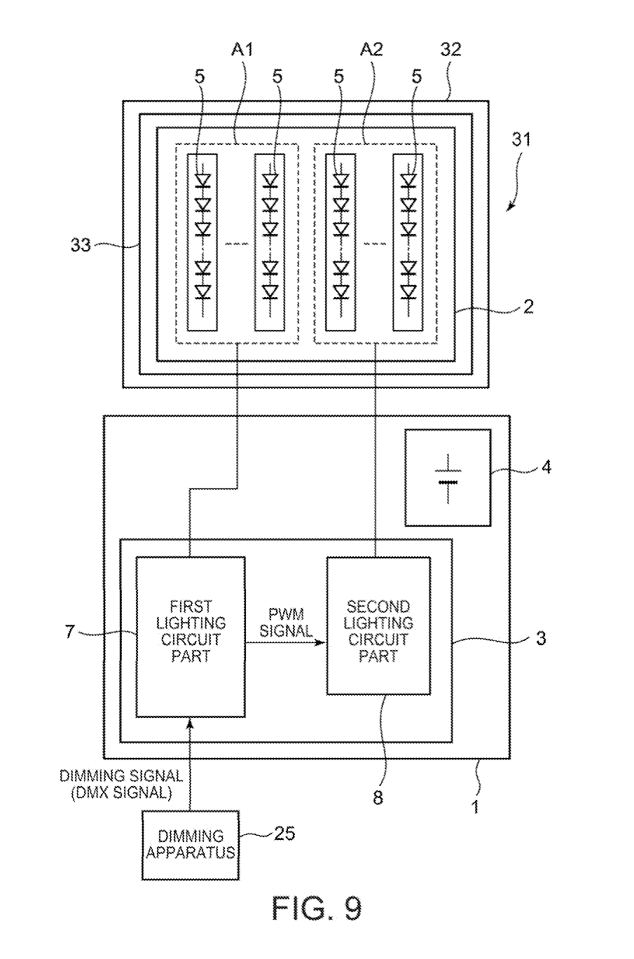

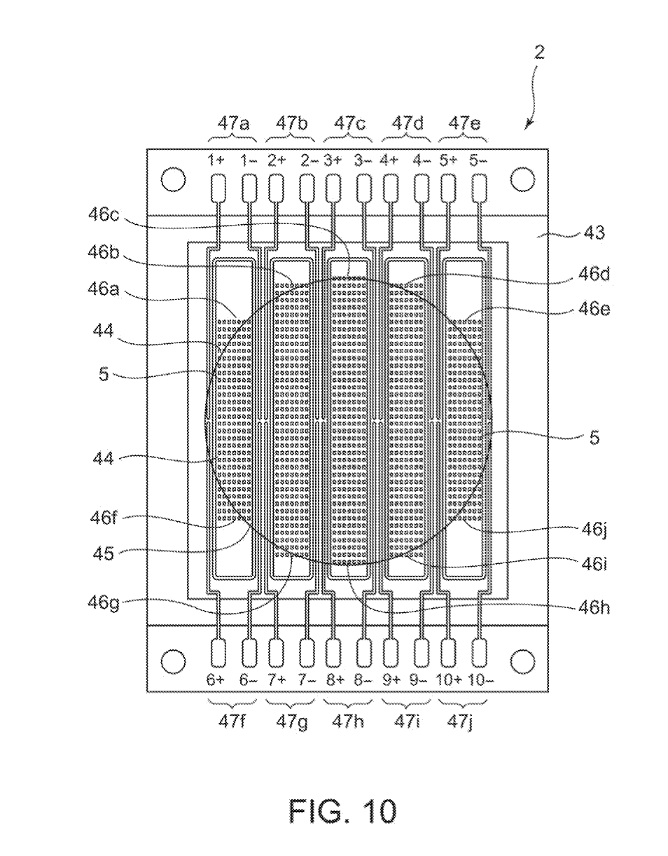

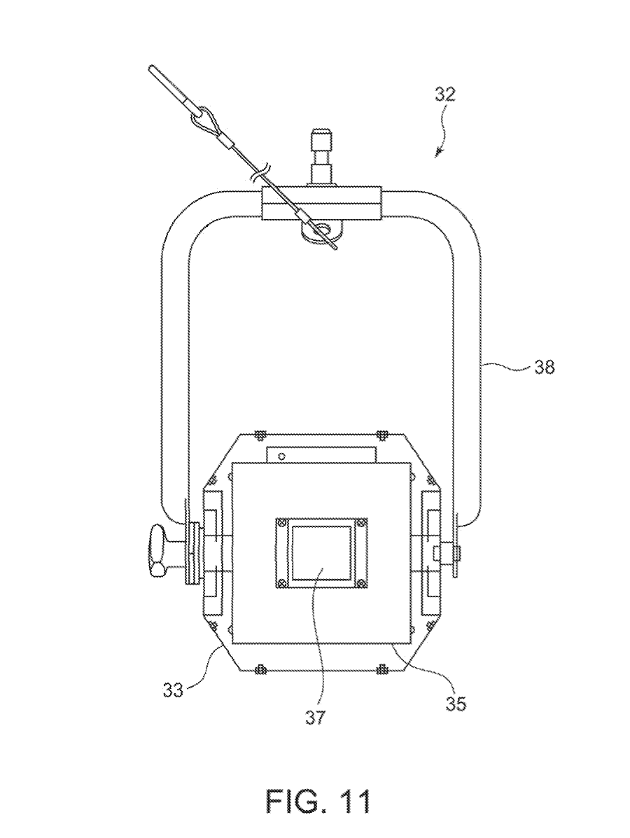

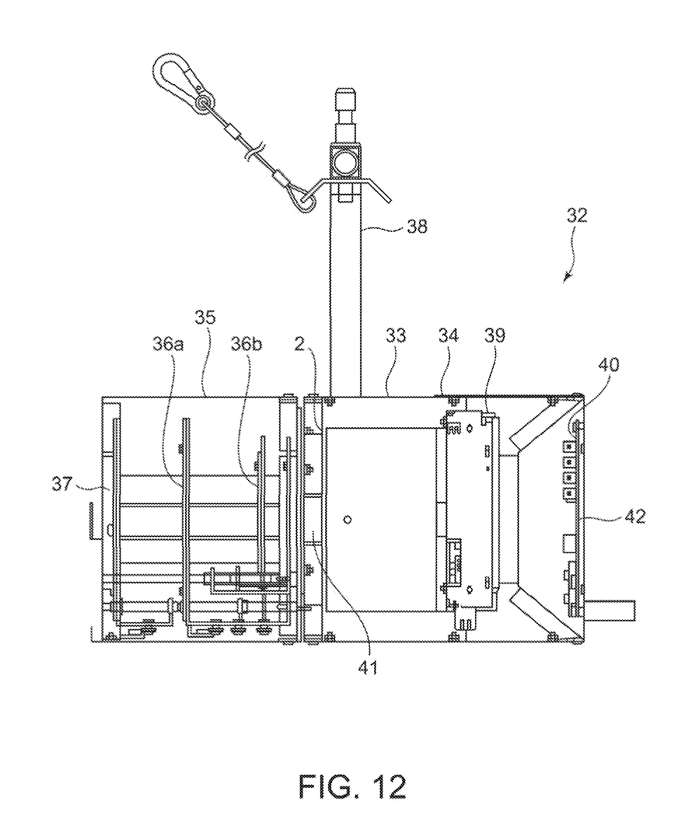

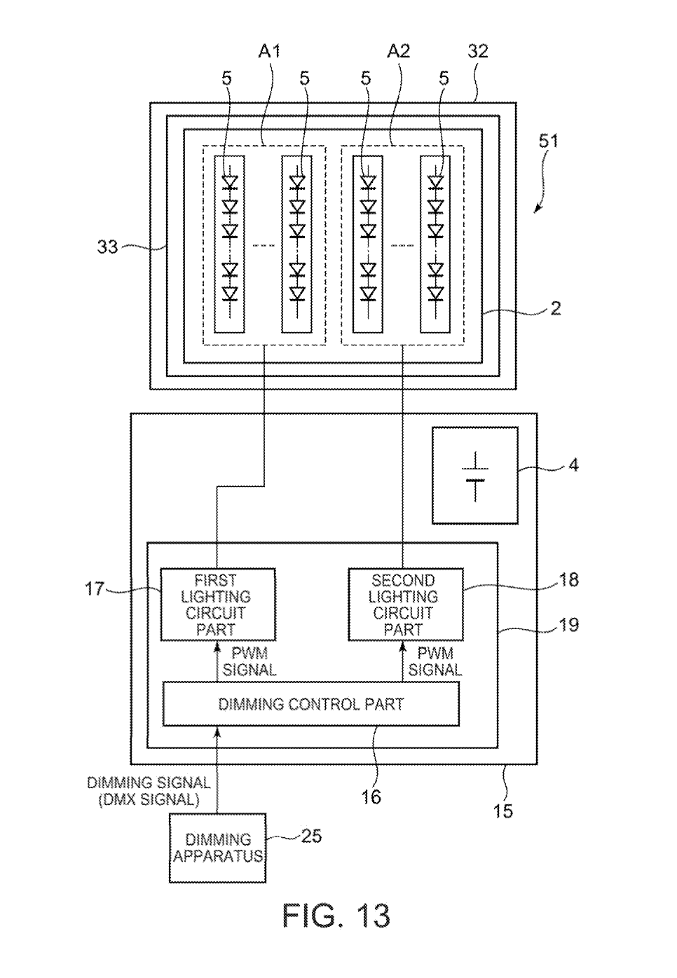

FIG. 9 to FIG. 13 show the third embodiment of the invention. FIG. 9 is a schematic block diagram of an illuminating apparatus, FIG. 10 is a schematic front view of a light source, FIG. 11 is a schematic front view of an LED luminaire, FIG. 12 is a schematic side sectional view of the LED luminaire, and FIG. 13 is a schematic block diagram of another illuminating apparatus. Incidentally, the same portions as those of FIG. 1 to FIG. 4 are denoted by the same reference signs and their description is omitted.

As shown in FIG. 9, an illuminating apparatus 31 of this embodiment includes the dimming apparatus 25 as a dimming part, the light-emitting diode lighting apparatus 1 shown in FIG. 1, and an LED luminaire 32.

The dimming apparatus 25 is, for example, a dimming stand which transmits, for example, a DMX signal as a dimming signal of 256 gradations. The DMX signal is a digital signal which is standardized by The United States Institute for Theatre Technology (USITT) and is used in the staging fielder the like, and indicates DMX512 which is used as a standard of a dimming signal for dimming control. The dimming apparatus 25 transmits the DMX signal at a period of, for example, 20 ms.

The LED luminaire 32 includes a main body 33 in which the light source 2 is provided. As shown in FIG. 12, the LED luminaire 32 is, for example, a spotlight, and the main body 33 includes a light source unit 34 and a lens unit 35. Radiated light of the light-emitting diodes 5 is emitted from the light source unit 34. The lens unit 35 includes projection lenses 36a and 36b which condense the light and project the light to the outside. As shown in FIG. 11, the light emitted from the light source unit 34 transmits through a transparent part 37 provided on the front of the lens unit 35 and is projected to an illumination object. The main body 33 is attached to an arm 38, which is attached to a structure such as a ceiling, so that the projection direction can be freely rotated.

In FIG. 12, the light source unit 34 is provided with the light source 2 which is a planar light source, and heat generated by the light source 2 is radiated to the outside space by a not-shown thermal radiator. The light source unit 34 includes a power supply part 39 to supply lighting power to the light source 2, a control part 40 to perform lighting control of the light source 2, a tubular light path 41 and the like. The power supply part 39 includes the drive circuit 6 of the light-emitting diode lighting apparatus 1 shown in FIG. 1, the direct-current power supply circuit 4 and the like. In the control part 40, the PWM control circuit 9 and the transmission and reception circuit 13 are formed of electronic parts mounted on a circuit board 42. A not-shown transmission line is connected to the circuit board 42, and the control part 40 inputs a dimming signal transmitted from the dimming apparatus 25 through the transmission line. The tubular light path 41 is for guiding the light of the light source 2 to the lens unit 35.

As shown in FIG. 10, in the light source 2, plural chip light-emitting diodes 5 are mounted on a tabular printed board 43. The light-emitting diodes 5 emit white light. Incidentally, light-emitting diodes 5 to emit red, green and blue lights may be used for complementary colors.

The light source 2 is grouped into plural LED circuits 44 in which the plural light-emitting diodes 5 are connected in series and are rectangularly arranged. The plural LED circuits 44 are combined so that a light emission area approximates a virtual circle 45.

The light source 2 is grouped into ten LED circuits 46a to 46j. The respective LED circuits 46a to 46j include power supply terminals 47a to 47j individually. The lighting power is supplied from the power supply part 39 to the power supply terminals 47a to 47j by lighting control of the control part 40, and the light-emitting diodes 5 of the respective LED circuits 46a to 46j are lit.

The respective LED circuits 46a to 46j are formed such that the plural light-emitting diodes 5 are rectangularly arranged, and are classified into three kinds different in arrangement of the plural light-emitting diodes 5 and different in size. In the three kinds of the LED circuits 46a to 46j, the lengths of the short sides of the rectangles are equal to each other, seven light-emitting diodes 5 are connected in series in the short side direction, and the series-connected circuits are connected in parallel in group units. The LED circuits 46c and 46h at the center part of the light source 2 are the longest group in which the length of the long side of the rectangle is longest. The LED circuits 46a, 46e, 46f and 46j at both end parts are the shortest group in which the length of the long side of the rectangle is shortest. The LED circuits 46b, 46d, 46g and 46i at the middle part between the longest group and the shortest group are the middle group in which the length of the long side of the rectangle is middle. The group A1 of the light-emitting diodes 5 shown in FIG. 1 is formed of the LED circuits 46a, 46c, 46e, 46g and 46i. The group A2 of the light-emitting diodes 5 is formed of the LED circuits 46b, 46d, 46f, 46h and 46j.

Since the illuminating apparatus 31 includes the light-emitting diode lighting apparatus 1, the illuminating apparatus can be formed at low cost, and can change the dimming level of the light source 2 of the LED luminaire 32 by the dimming signal transmitted from the dimming apparatus 25 and by the PWM signal. Further, there is an effect that the brightness change at the time of change of the dimming level can be made hard to recognize and can be made difficult for a person to perceive.

FIG. 13 shows another illuminating apparatus of the third embodiment of the invention. An illuminating apparatus 51 is such that in the illuminating apparatus 31 shown in FIG. 9, the light-emitting diode lighting apparatus 15 shown in FIG. 4 is used instead of the light-emitting diode lighting apparatus 1. The illuminating apparatus 51 has the same operation and effect as those of the illuminating apparatus 31 shown in FIG. 9.

According to the light-emitting diode lighting apparatus of the embodiment, the dimming control part inputs the dimming signal from the dimming part, and controls the outputs of the respective lighting circuit parts according to the dimming signal. When the dimming gradation is changed, the outputs of the plural lighting circuit parts are sequentially changed to new gradations in one period of the dimming signal. Thus, in the light source, at the time of change of the dimming level, the respective groups are sequentially lit at the dimming gradation corresponding to the dimming signal. By this, it is expected that the brightness change at the time of change of the dimming level of the light-emitting diodes does not become a rough digital change, but becomes a smooth change.

Although exemplary embodiments have been described, these embodiments have been presented by way of example only, and are not intended to limit the scope of the invention. Indeed, the novel apparatus described herein can be embodied in a variety of other forms, and various omissions, substitutions and changes in the form of the apparatus described herein can be made without departing from the gist or the spirit of the invention. The attached claims and their equivalents are intended to cover such forms or modifications within the scope of the invention and within the gist or the spirit thereof.

### CROSS-REFERENCE TO RELATED APPLICATION

This application is based upon and claims the benefit of priority from the prior Japanese Patent Application No. 2010-222275 filed on Sep. 30, 2010, and the prior Japanese Patent Application No. 2011-176664 filed on Aug. 12, 2011, the entire contents of which are incorporated herein by reference.

### REFERENCE SIGNS LIST

1, 1A, 15 . . . light-emitting diode lighting apparatus, 2 . . . light source, 5 . . . light-emitting diode, 7, 17 . . . first lighting circuit part as lighting circuit part, 8, 18 . . . second lighting circuit part as lighting circuit part, 9 . . . PWM control circuit constituting dimming control, part, 13 . . . transmission and reception circuit constituting dimming control part, 16 . . . dimming control part, 25 . . . dimming apparatus as a dimming part, 31, 51 . . . illuminating apparatus, 32 . . . LED luminaire

1. A light-emitting diode lighting apparatus, comprising:
a light source including a plurality of grouped light-emitting diodes;
a plurality of lighting circuit parts to perform lighting control of the respective grouped light-emitting diodes of the light source individually; and
a dimming control part that inputs a dimming signal from a dimming part and controls an output of each of the lighting circuit parts according to the dimming signal, and sequentially changes, when a dimming gradation is changed, outputs of the plurality of lighting circuit parts to new gradations in one period of the dimming signal.

2. The light-emitting diode lighting apparatus according to claim 1, wherein in the dimming control part, a time for changing the outputs of the lighting circuit parts can be changed according to a change amount of the dimming gradation of the dimming signal inputted from the dimming part.

3. The light-emitting diode lighting apparatus according to claim 1, wherein in the dimming control part, a time for sequentially changing the outputs of the lighting circuit parts can be changed according to a period of the dimming signal inputted from the dimming part.

4. An illuminating apparatus comprising:
a dimming part for outputting a dimming signal corresponding to a dimming gradation at a specific period;
a light-emitting diode lighting circuit according to any one of claims 1 to 3, which dims and lights a light source according to the dimming gradation of the dimming signal transmitted from the dimming part; and
an LED luminaire including a main body in which the light source of the light-emitting diode lighting circuit is provided.

5. A lighting method of an illuminating apparatus provided with a light source including a plurality of grouped light-emitting diodes, and a plurality of lighting circuit parts to perform lighting control of the respective grouped light-emitting diodes individually, comprising:
inputting a dimming signal to the respective lighting circuit parts;
controlling an output of each of the lighting circuit parts according to the dimming signal; and
sequentially changing, when a dimming gradation corresponding to the dimming signal is changed, outputs of the plurality of lighting circuit parts to new gradations in one period of the dimming signal.
